(19) United States
(12) Patent Application Publication
(10) Pub. No.: US 2005/0111775 A1
(43) Pub. Date: May 26, 2005

(54) Method and apparatus for a dynamically reconfigurable waveguide in an integrated circuit

(76) Inventors: Vitaly Fridman, Bensalem, PA (US); Leo Finkelstein, San Francisco, CA (US); Bruce Gray, Danville, CA (US)

Correspondence Address: Robert E. Krebs;Thelen Reid & Priest LLP, P.O. Box 640640, San Jose, CA, 95164-0640, US

(21) Appl. No.: 10/924,753

(22) Filed: Aug. 23, 2004

Related U.S. Application Data
(60) Provisional application No. 60/497,190, filed on Aug. 21, 2003.

(51) Int. Cl. G02B 6/12

(52) U.S. Cl. 385/14; 385/129

(57) ABSTRACT

A re-configurable optical waveguide includes an electro-optic substrate and plurality of electrodes above substrate. Electrodes are forming photonic crystal waveguide with photonic crystal periodic structure which has a slab optical waveguide on the top surface of a substrate and also has refractive index variation areas due to electro-optical effect with a different refractive index from that of the core layer of the slab optical waveguide arranged in a lattice array shape at part of the slab optical waveguide. In this case, the refractive index variation areas are formed of the same material as the material constituting the core layer of the slab optical waveguide. The refractive index variation areas are arranged in the lattice array shape on both the sides of an optical waveguide area, where light is propagated. The refractive index of the core layers of the refractive index variation areas is larger than that of the core layer of an area of the refractive index variation area. A plurality of electrodes are placed a field emission array with structure density possibly being higher than 10+8 per square centimeter. Groups of the structures are united in pixels with size a equal to the waveguide's width. Different arrays of pixels form variable shapes and, appropriately, variable waveguides. Thus light propagates in the different directions according the waveguide which is formed. Such a waveguide allows implementation of different optical functions simply by changing the arrangement of the patterns. Arrangement of the patterns is controlled with integrated transistor structure, and with a coupled control circuit.

### CROSS-REFERENCE TO RELATED APPLICATION

This application claims priority based on U.S. Patent Provisional Application Ser. No. 60/497,190, entitled “Method and Apparatus For A Dynamically Reconfigurable Waveguide In An Integrated Circuit” by Vitaly Fridman, Leo Finkelstein, and Bruce Gray, filed on Aug. 21, 2003.

### FIELD OF THE INVENTION

The present invention relates to waveguides implemented on an integrated circuit. More specifically, the invention relates to a dynamically reconfigurable waveguide implemented in the context of an integrated circuit.

### BACKGROUND OF THE INVENTION

Optical devices such as optical waveguides are used in communications and data processing equipment. These devices are used to transfer information from one location to another, to code and/or switch the information to a particular desired output. The information is usually in the form of a continuous or a pulsing optical signal.

Typical waveguides contain a core made of a material that transmits light of a desired wavelength. The core is usually clad in a material that abuts at least one side of the core. Multiple cores can be used to form switches to switch an optical signal to desired output core. Multiple core waveguides may also be used as filters. In this manner, the use would be to filter one or more optical signals of a particular wavelength. Multiple core waveguides can also be used in multiplexers to combine or separate optical signals of different wavelengths.

Optical cores can be linear. However, they may also curve in order to direct a signal from one location to another within the confines of a small space.

In many conventional waveguides, light is confined by total internal reflection (TIR). That is, the impinging light is all reflected with no refraction. Thus, for typical materials, the differences in the reflective indices dictate that the incident optical energy must fall on the core wall at a shallower angle rather than one nearer to the normal. Accordingly, the radius of the core material is typically large to accommodate this property. If the radius of the bend is large compared to the wavelength, much of the light will be lost.

In the TIR methodology, the creation of these bends can be troublesome. In these waveguides, if the direction of an optical signal is to be changed 90 degrees, the core must be fabricated to accommodate this. In typical examples, the core can have a radius of 10 mm or more to avoid losing much of the optical signal to the cladding in the curved section. Consequently, for every 90 degrees of turn incorporated along the length of a device adds approximately this 10 mm to at least one dimension of the device. As such, this property adds added size and complexity to the end device.

This inhibits the ability to further miniaturize the end component. Further, much of the end component may end up as “dead space” due to the restriction in turning radii due to the TIR phenomena.

Secondly, propagation times are expanded due to the TIR phenomena. The added turns give rise to additional path length for the transmitted optical signal. This leads to further propagation delays.

Towards these goals, scientists have long been working towards producing efficient and easily configurable photonic band gap (PBG) materials. These PBG materials are typically crystalline structures that exclude light transmission in all directions for specific wavelength ranges, just as semiconductors exclude electron propagation for certain energy bands.

These PBG materials are typically seen as photonic crystals. Photonic crystals are artificial 3-, 2-, or 1-dimensional structures fabricated in an optical material. The optical material can be crystal or amorphous.

The photonic crystals typically exist as unit cells whose dimensions are comparable to the optical wavelength. If the artificial structure has an appropriate symmetry or geometry, it can exhibit a photonic band gap, thus forming a photonic band gap (PBG) material or crystal. Typically, the manufacture of such a photonic crystal is accomplished by nanofabrication of a structure, which has, for example, 2-dimensional periodicity.

An effort has been undertaken to produce two-dimensional photonic crystal structures by etching holes into thin films of dielectrics and semiconductors. The natural modes of such etched layers—the Bloch waves—exhibit the property that an optical signal can approach a periodic dielectric interface at normal incidence and yet be totally internally reflected.

Such two-dimensional crystals can be used to produce highly miniature components that can be integrated in large numbers on to one substrate. However, a traditional photonic crystal waveguide, which is created by etching holes, is permanent in nature. As such, a waveguide made in this manner or having this particular structure cannot be dynamically re-configured.

### SUMMARY OF THE INVENTION

A dynamically re-configurable waveguide is envisioned. The waveguide is made of a baseplate and an electro-optic material coated plate with ground electrode spaced apart from the baseplate.

An electron emitting array is formed on the baseplate. The array has a plurality of emitters positioned so that electrons emitted from any of the plurality of emitters impinge on a particular section of the electro-optic material coated plate. The emitters having a top portion and a bottom portion, the top portion nearer to the electro-optic material than the bottom portion. The top portion having a smaller dimension than the bottom portion.

The electrons, when emitted, operate to change the refractive index of the electro-optic material. At least one spacer is operationally positioned between and separating the baseplate and the electro-optic material coated plate.

The emitters can be conical in nature. The density of emitters can be approximately 10+8 per square centimeter, or more. The distance between the adjacent top portions is usually less than a wavelength of a propagated light.

An aspect comprises a plurality of gates. The gates are disposed in a layer above each emitter, and each of the plurality of gates has a dimension of less than half the wavelength of a propagated light.

The plurality of emitters can be placed into a group, where the group defines a set of controllable emitters. The group can contain between approximately one hundred emitters and many thousands of emitters. In one aspect, the group forms a triangular shape.

The electron emitting array creates, in response to a common applied voltage, a two-dimensional subwavelength periodicity on the electro-optic material coated plate with a different refraction index. The electron emitting array, in response to a common applied voltage which is parallel to polarization vector of the electro-optic material, creates a region in the electro-optic material that is characterized by total internal reflection guiding.

The electron emitting array, in response to a common applied voltage which is parallel to polarization vector of the electro-optic material, creates a region in the electro-optic material that is characterized by photonic band gap guiding.

In other aspects control circuitry controls the activation of the emitters. As such, the waveguide is dynamically configurable.

### DESCRIPTION OF THE FIGURES

FIG. 1 is a sectional diagram of one aspect of the invention.

FIG. 2 is a rendition of an electron micrograph of a single Spindt type field emission structure with gate and a section of field emission array.

FIG. 3 is a side schematic view detailing the spatial relationships of several portions of an aspect of the invention.

FIG. 4 is a side schematic level view of an embodiment of the invention having an integrated transistor structure and control circuitry.

FIG. 5 is a planar view of another geometry of structure that can be used in accordance with the invention.

FIG. 6 is a schematic diagram detailing the possible linkages of an aspect of the invention.

FIG. 7 is a hatch-section of a device according to one aspect of the invention.

FIG. 8 is a side schematic detailing the structure of an alternative construction of a device in accordance with the invention.

FIG. 9 is a cross sectional view of an electro-optical polymer layer as might be found in the structure of FIG. 8.

FIGS. 10a-b are top-level views of an exemplary electro-optical polymer layer of FIG. 9 in accordance with the invention.

FIGS. 11a-b are top-level views of an alternative exemplary electro-optical polymer layer of FIG. 9 in accordance with the invention.

FIGS. 12-15 are schematic diagrams detailing the interaction of multiple sections of the waveguide operating in a reconfigurable manner according to an aspect of the invention.

### DETAILED DESCRIPTION

A dynamically configurable waveguide and the method of manufacture is hereby described. A waveguide is created in an electro-optic material. In this manner, this allows for a PBG material, where the gap could be opened or closed at will. Further, the gap may be tunable. The range of forbidden wavelengths at a specific location in the structure can be adjusted by a local electric field. The electric field may be produced with circuitry placed around the electro-optic material. In some cases, with his structure, the band gap can be eliminated altogether.

The invention envisions an integrated optical processor made of a slab of the material, and surrounded by a mesh of wires. Each of the mesh of wires can produce a localized electric field. In this manner, the electric field from the wires not only may be used to configure the waveguides, but the integrated optical circuit could be changed at any time. The optical circuit may even be programmed to “learn” which particular configurations operate better for a given situation.

The wires can be made with field emission arrays. These allow for high-precision computer control of an electron beam in location, time and direction of motion. This enables the generation of specific waveguide geometries and any selective deformation needed to serve the intended optical purpose. In this manner, the optical behavior of the waveguide structures can be tailored to meet the desired needs.

By applying an electrical field to the electro-optical substrate, the optical path in the substrate, and hence its properties, can be set electrically. This allows the optical transmission characteristic to be shifted, the direction of the light to be varied, and in some cases the intensity to be varied.

In an electro-optical material, when an electric field is applied parallel to the polarization vector, this produces a local refractive index decrease in the material. This relationship can be quantified by the following:
n=nₑ−½n³ₑr₃₃E₃,
where n is the effective refractive index, nₑ is the extraordinary index of refraction, r₃₃ is the electro-optic coefficient, and E₃ is the applied field component along the spontaneous polarization of the ferro-electric optical material.

Thus, when electric field is applied along the spontaneous polarization, this results in an effective decrease of the effective refraction index. Using this property, one can create waveguides by creating 2-dimensional periodic cladding around these structures. As such, total internal reflection guiding can be achieved.

Due to: 1) the lower effective refraction index around the waveguide; and 2) subwavelength periodicity, the propagated light sees a series of layers. These layers have alternating high- and low-refractive indices.

Multiple reflection and refraction can occur at the interfaces between the layers. This property, along with interference, allows the propagated light to be reflected back. This can happen for wavelengths approximately equal to twice the period.

The width of the reflectance band is defined by the wavelengths between which the reflectance increases as layers are added. Generally, in this manner low absorption and high reflectivity are obtained.

For the propagated light in some wavelengths, the effective index as determined with numerical methods is complex in nature, having a real and an imaginary portion. The imaginary part does not imply any heat dissipation because the alternate layers are made of transparent materials. This signifies that waves cannot propagate. The value is inversely proportional to the penetration depth.

In addition to the TIR property, photonic band gap guiding is also present. This is due to the presence subwavelength periodicity. Both of these effects are achieved by applying external electric field with periodically structured field emission arrays.

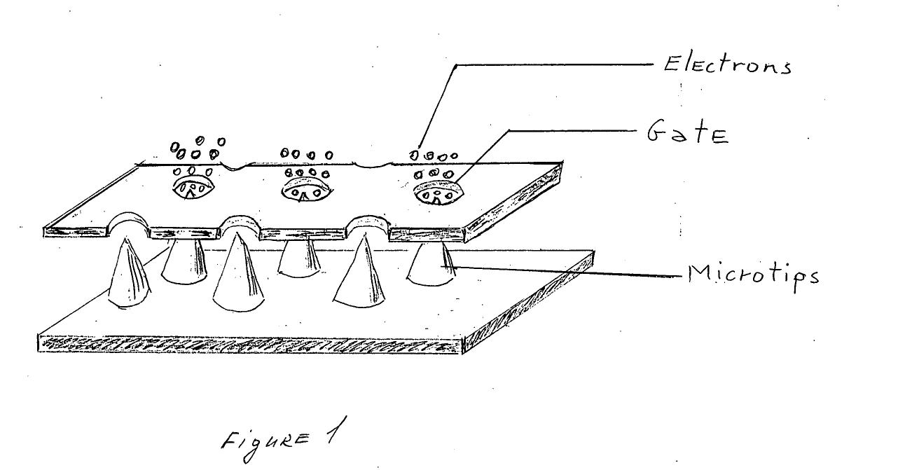

FIG. 1 is a sectional diagram of one aspect of the invention. In this concept, a field emission array (FEA) is used to achieve the appropriate interaction. The FEA is a large number of small structures.

In one embodiment, the structures are conical tips with periodicity about λ, sitting beneath λ/2 width gates. When a voltage differential is applied between tip and gate, the electric field at the tip much higher than that at the gate. The electric field at the tip initiates a cold cathode emission. This results in a cloud of electrons hovering over the tip.

Once liberated, these electrons stream to a proximately placed anode. This anode can be the electro-optic polymer film on a silicon substrate, for example. The liberated electrons migrate to the anode and produce an associated external electric field.

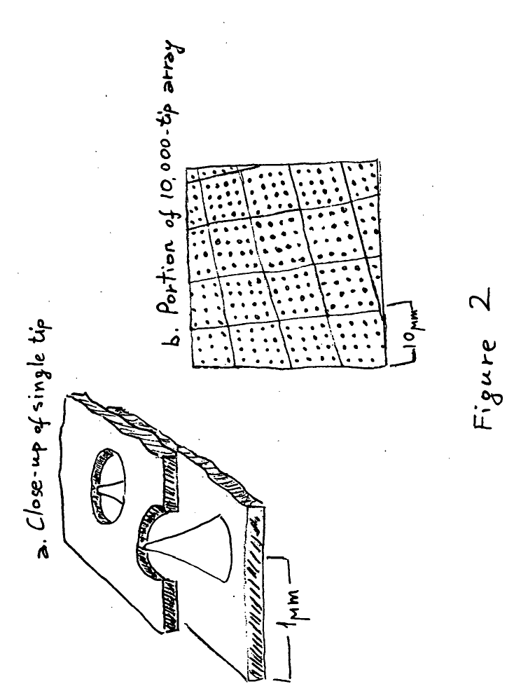

FIG. 2 is a rendition of an electron micrograph of a single Spindt type field emission tip with gate and a section of field emission array. The field emission arrays can be made up of an insulating layer sandwiched between two conductors. An array of holes is present in the top conducting film and in an associated insulating layer.

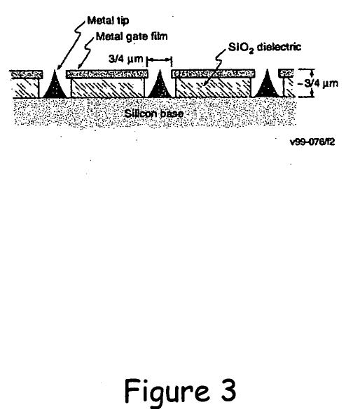

FIG. 3 is a side schematic view detailing the spatial relationships of several portions of an aspect of the invention. The top conductor is referred to as the gate, and the lower conductor is referred to the base. These arrays can be manufactured on any flat, smooth, ultra-vacuum-compatible substrate, either insulating or conductive.

The emitter tips can be fabricated in the array of holes using thin film deposition techniques. They can be fabricated with sub-micron hole spacing, with packing densities of over 10⁸ tips/cm².

In such an emitter structure, the emission level is controlled by adjusting the voltage of the gate layer relative to the emitter tips. Due to the small scales involved, a small voltages (typically less than 100 volts) can be used to control the emission from each tip.

With these types of operations, electron emitting capacities of up to 100 microamps have been demonstrated with single tips. This can result in capacities of 5000 amps/cm² or upwards for arrays, depending upon geometries.

Many features are found in these structures. With high current densities, and the inherent small size and small mass of microfabricated devices, the field emission arrays have excellent characteristics for creating waveguides on the electro-optic substrates. Further, low power consumption, clean operation, no use of expendables, high efficiency, long lifetime, and a large operational temperature range (from approximately −270 degrees C. to over 400 degrees C.) can also define these structures.

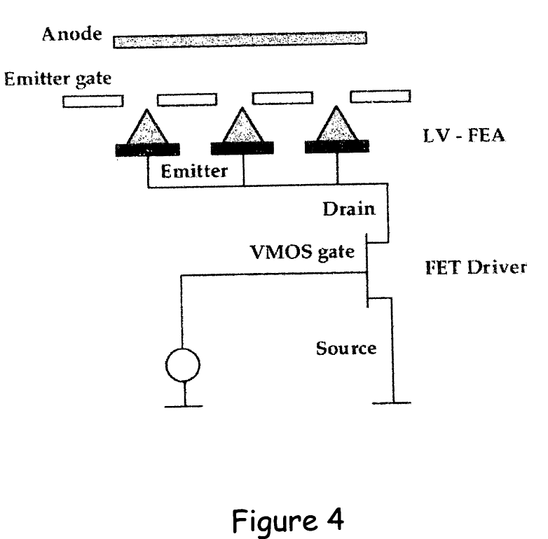

FIG. 4 is a schematic diagram detailing a possible wiring schematic for controlling the emitters in accordance with the invention. A switch is used to enable a current flow to the emitter array, or a predefined group of emitters. When the switch enables the current flow, an electric field is created in the optical wave guide layer, thus creating the configurable wave guide in the wave guide layer.

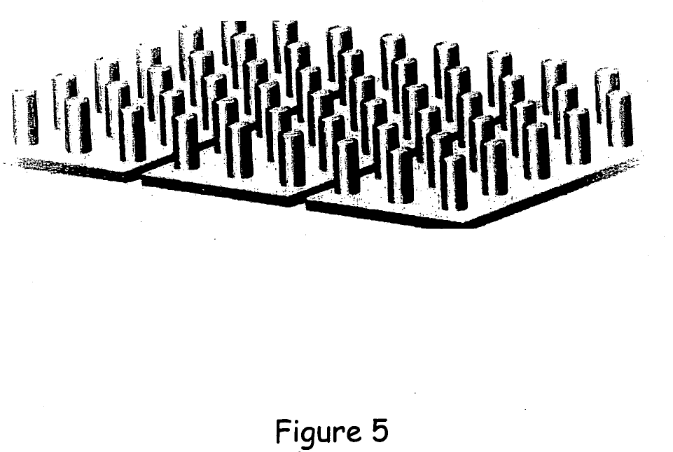

FIG. 5 is a planar view of another geometry of structure that can be used in accordance with the invention. In this embodiment, the structures are cylindrical in nature. In this case, the structures can sit with a periodicity of about λ. When the voltage is applied, the same electrical properties and functions as described previously can be generated. Of course, this disclosure is not limited as to the geometries. Other geometries, shapes, and spacings of the structures should considered as part of this disclosure.

To create waveguides using field emission arrays on the electro-optic substrates, the structures are grouped. Each group can be made up of any numbers of structures. Typically, the groups number from hundreds to thousands structures.

The size of the group is defined by the width of the waveguide. One highly usable grouping is in the form of a triangle. The triangle grouping is very usable for at least two reasons. First, a unit lattice of the structures' periodicity is in a regular triangle array. This is compatible with a triangular grouping. Second, a grouping with triangle form allows the creation of waveguides having 60° degree inherent angles. This in turn allows greater miniaturization and provides fewer insertion loses.

As mentioned before, both the gate and the cathode driver work best with a high output drive voltage, in some cases up to 100 volts. A low voltage logic can be integrated on the same chip to support a row line scanning and a column line pulse width modulation conversion function, respectively.

Thus, an array of structures grouped together is envisioned. In this case, an actively addressed group retains on/off information within the group between frame scans. This reduces the necessary refresh rate if the actively “on” or “off” group state does not need to be modified on the subsequent configuration of the waveguide.

In one case, a field emission array is constructed with an integrated transistor structure to form the basis of a group latch sub-system. A transistor can be used to isolate the group latch element from the electro-optic substrate row and column address lines. In this manner, an addressing of each group is created.

FIG. 4 is a side schematic level view of an embodiment of the invention having an integrated transistor structure and control circuitry. Using this structure, it is possible to modulate the field emission current density by adjusting the vertical MOSFET (VMOS) gate voltage.

The row connections can be connected to the extraction gates, and the columns are, in this case, connected to the cathode. The rows can be scanned sequentially from top to bottom. During each row select time, the column connections are used to impart intensity information to the group. The group intensity can also be modulated in time.

Turning now to the substrate, the velocity of light in the material is determined by the interaction of the electric field component of light with the charges (electronic and nuclear) of the material. The effect is quantitatively defined by the index of refraction, n, of the material. This index of refraction is equal to the ratio of the speed of light in a vacuum to the speed of light in the material.

Assume that an electric field is applied to a material with sufficient magnitude to change the charge (e.g., electronic) distribution of the material. This changes the velocity of light in the material, and as such alters the index of refraction of the material.

In one embodiment, polymer electro-optic materials have some advantages over crystalline electro-optic materials. First, the polymer has exceptional bandwidth.

Second, the polymer has a low permittivity relative to crystalline electro-optic materials, such as ferroelectric lithium niobate. This can allow the positioning several individual waveguides close to one another absent significant frequency crosstalk between these waveguides, relative to the crystalline electro-optic material.

Third, polymer usage is very relevant to high-density packaging and integration with very large scale integration (VLSI) semiconductor electronics. Polymeric electro-optic materials can be deposited onto and will adhere to many substrates including semiconductor electronics. Additionally, these polymers can be fabricated on flexible substrates, such as Mylar. His allows the fabrication of conformal devices.

This compatibility of electro-optic polymers with a variety of materials is helpful in the development of opto-chips. These polymers are highly suited for the development of integrated opto-electronics packages where control, drive, and interface electronics are directly integrated with polymeric electro-optic devices. A final advantage of polymeric electro-optic materials is the potential for high electro-optic coefficient and lower operating voltages.

The first step in manufacturing a device envisioned involves spin casting an unpoled polymer film. An appropriate solvent is chosen to lead to an appropriate viscosity, compatible with chromophore and polymers. The solvent should capable of being completely removed from the final film.

Spin casting should be carried out in a sterile environment. This is since dust particles can lead to significant light scattering and optical loss in the device.

For macroscopic electro-optic activity to be finite (non-zero), chromophores must exhibit net acentric order, i.e. they must be oriented to yield a dipolar chromophore lattice. Such acentric (or non-centrosymmetric) order is introduced by electric field poling. The poling field typically has some symmetry, i.e., such as applied along the z-laboratory axis. In one embodiment, the strength of the field is up to 100V/μm and poling temperature is up to 200 degrees C. for about 1 hour.

Electro-optic activity induced by electric field poling should be stable at temperatures encountered in device fabrication and operation. This implies long term stability for operating temperatures as high as 125 degrees C. and short-term stability for temperatures approaching 200 degrees C.

Two strategies for achieving this high thermal stability of poling-induced electro-optic activity can be pursued. The first is to prepare the chromophore/polymer composite materials where the polymer is a high glass transition temperature (T_{g}) polymer such as polyimide. Acentric chromophore order is induced by poling the chromophore/polymer composite material near its glass transition temperature. Cooling the material to room temperature, in the presence of the electric poling field, locks in the poling-induced electro-optic activity.

The second approach is to make use of covalent coupling of chromophore and polymer and to effect some sort of lattice hardening during the later stages of poling. Since poling and lattice hardening are both temperature-dependent processes, optimum electro-optic activity and lattice hardening are usually achieved using a protocol wherein temperature and electric field are increased in a series of steps. An initial temperature jump increases chromophore mobility and permits the chromophores to reorient in the presence of the applied electric field.

The increase in temperature drives further crosslinking. This ultimately stops chromophore reorientation in the field, thus requiring another temperature increase. Application of an electric field that is too strong to a soft lattice can cause material damage and increase optical loss. Thus, a stepped protocol also greatly reduces poling-induced optical loss.

Optical losses associated with electric field poling can be diverse. A major, but avoidable, component of poling-induced loss is associated with surface damage of polymer films arising from applying too high a voltage (particularly with corona poling) to a polymer film that is too soft. This component of poling-induced loss can be reduced to insignificant values by employing stepped poling protocols where field strength is increased in a stepwise manner as the polymer lattice is hardened.

Another component of poling-induced loss that is also easily avoided is that of chromophore migration and phase separation occurring during the poling of composite materials. Covalent attachment of the chromophore to the polymer normally eliminates this type of loss.

Thus, poling-induced optical losses can be reduced to insignificant values (e.g. <<1 dB/cm) by careful control of spin casting and poling conditions. Maintenance of material homogeneity is critical, including contamination by dust particles, and by avoiding phase separation during spin casting, poling, and lattice hardening.

Integration of electro-optic polymer with VLSI semiconductor electronic circuitry should be accomplished with avoidance of optical loss associated with the underlying irregular topology of VLSI wafers. Such an optical loss can be reduced through the use of planarizing polymers.

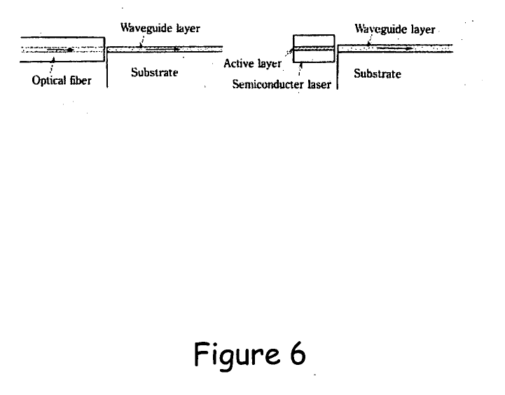

FIG. 6 is a schematic diagram detailing the possible linkages of an aspect of the invention. The next step in preparing the electro-optic polymer substrate is the input/output fiber coupling. The optimum optical mode pattern in fiber is usually nearly circular while that in electro-optic polymer waveguide is a relatively flat ellipse. This mismatch in mode shapes and difference in index of refraction of the fiber and electro-optic polymer means that two waveguides cannot be simply joined together.

This problem can be solved by preparing the electro-optic polymer substrate with a thickness of polymer film close to that of the future waveguide's width. Further, the introduction of an optical mode pattern close to the circular should be performed.

Mismatch due to a difference in the refraction index difference can be reduced. This may be accomplished by attaching a fiber to the base substrate in a V-groove and performing a spin casting process with the attached fibers. In this case, the air gap between the fiber and the polymer is eliminated.

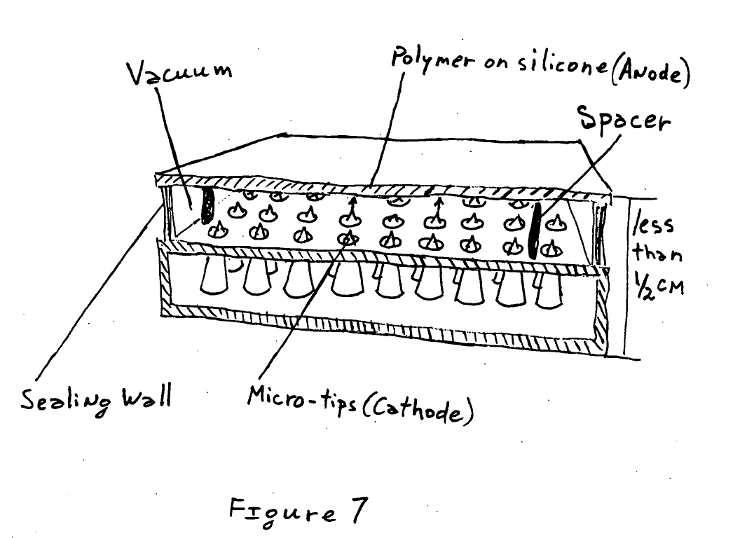

FIG. 7 is a hatch-section of a device according to one aspect of the invention. In this case, the prepared electro-optic polymer substrate is connected to field emission array substrate. The structure also contains spacers and sealing walls. These may be performed with a laser-assisted vacuum packaging process.

The control of each group may be accomplished by turning “on” or “off,” an appropriate signal or signals. In this manner, the waveguide image can be created.

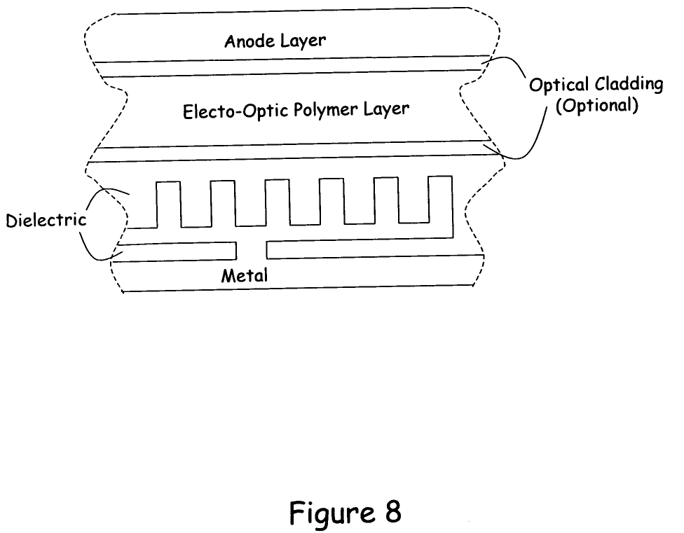

FIG. 8 is a side schematic detailing the structure of an alternative construction of a device in accordance with the invention. In this case, a metal connection layer runs within a semiconductor device. This layer is coupled to metal structures, such as those indicated and described in relation to FIGS. 3 and 4, previously. A dielectric layer can envelope the metal structures is necessary. An electro-optic polymer layer is in close proximity to the metal structures. An anode layer adjoins the electro-optical polymer layer.

When a current passes through the electric structures, a voltage is created between the structures and the anode layer. As such the electric field is produced in the electro-optical polymer layer that lies between the structures and the anode layer.

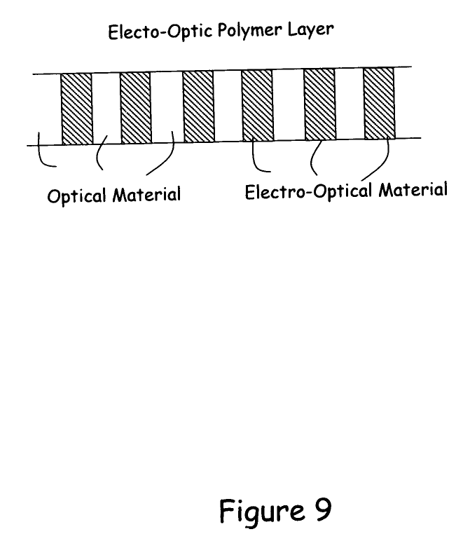

FIG. 9 is a cross sectional view of an electro-optical polymer layer as might be found in the structure of FIG. 8. In this case the electro-optical polymer layer is made from two differing materials. The first material is a volume of an optical material. The optical material has a refractive index of n1. Interspersed are volumes of an electro-optical polymer material that has a variable refractive index, the refractive index being dependent upon a voltage as described above.

When a current is introduced to a metal layer (not shown in FIG. 9) adjoining the electro-optical polymer layer or through the structures as described previously, a voltage is introduced across the electro-optical polymer volumes. When the voltage is present, the refractive index of the electro-optical polymer volumes changes, thus changing the optical properties of the electro-optical polymer layer.

This wave guide layer may be made with semiconductor manufacturing processes as well. The base material can be laid on the device using the spin casting process described previously. A mask layer corresponding to the geometries in which the base optical material is to be preserved is than added. Next, the remainder can be etched away, leaving interstices corresponding to the portions of the wave guide layer corresponding to the second material. Next, the second material is laid down, forming structures of the second material interspersed in the matrix of the first material. Unwanted material in the vertical direction may be ground or etched away. Of course, many other methodologies may be employed in creating the matrix of the materials in the combination layer.

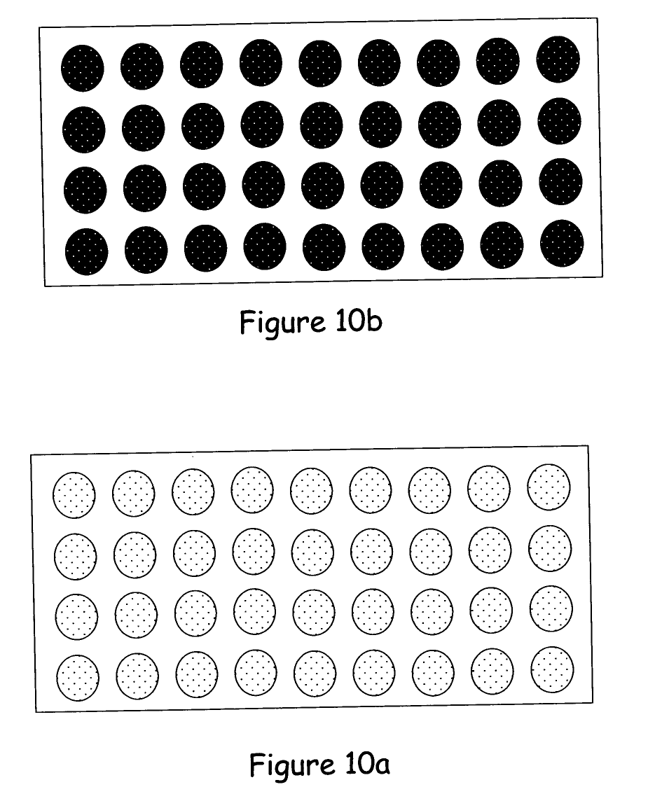

FIGS. 10a-b are top-level views of an exemplary electro-optical polymer layer of FIG. 9 in accordance with the invention. An electro-optical polymer layer may be constructed with the interleaved volumes of optical material and electro-optical polymer material. In the case of FIG. 9a, the electro-optical polymer material has a refractive index n2 when no voltage is present, where n2=n1. In this case, the refractive index of the electro-optical polymer material matches the refractive index of the optical material, and light passes through the materials.

In FIG. 10b, a voltage is applied across the electro-optical polymer layer. In this case, the refractive index of the electro-optical polymer material changes to n3, where n3<n1. In this case, the differing refractive indices of the optical material and the electro-optical polymer material inhibit the transmission of light energy through the electro-optical polymer layer.

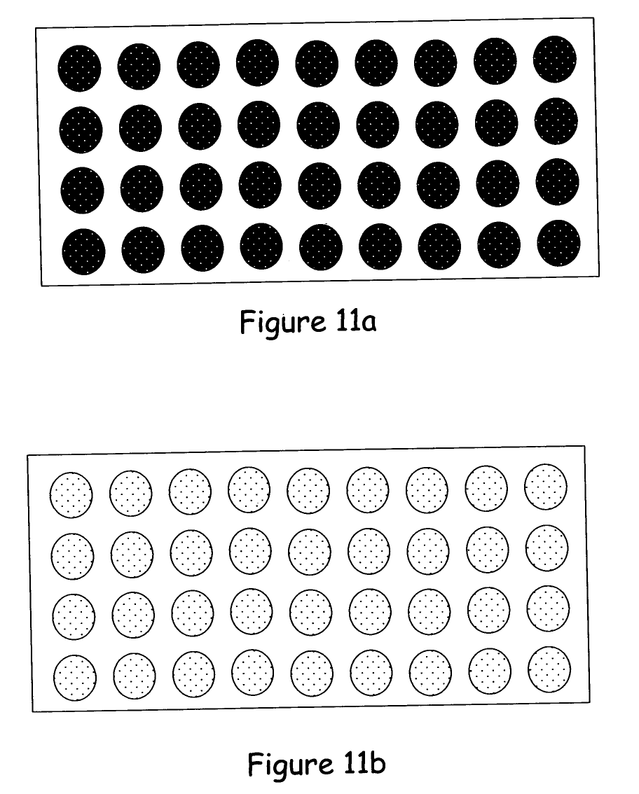

FIGS. 11a-b are top level views of an alternative exemplary electro-optical polymer layer of FIG. 9 in accordance with the invention. Again, the electro-optical polymer layer may be constructed with the interleaved volumes of optical material and electro-optical polymer material. In the case of FIG. 9a, the electro-optical polymer material has a refractive index n4 when no voltage is present, where n4>n1. In this case, the refractive index of the electro-optical polymer material in conjunction with the refractive index of the optical material inhibit the transmission of light energy through the electro-optical polymer layer when there is no voltage.

In FIG. 11b, a voltage is applied across the electro-optical polymer layer. In this case, the refractive index of the electro-optical polymer material changes to n5, where n5=n1. In this case, the voltage causes the refractive indices to be equal, and thus allows the transmission of light energy through the electro-optical polymer layer.

The electro-optical polymer layers in conjunction with FIGS. 8, 9, 10, and 11 may be constructed in a semiconductor fabrication facility. The current circuitry and the metallic structures of FIGS. 8 and 9 may be implemented in many ways known in the industry. An adjoining layer of an optical material, such as a polymer or glass, is laid down on the semiconductor device in a layer adjoining the current carrying circuitry and metallic structures. The polymer may be masked with the proper schematic of interleaved polymer structures, and then etched. An electro-optical polymer fill is then performed, resulting in the combined electro-optical polymer layer with the proper configuration. Of course, other methods of performing the construction of this layer are known, and the description should be read as to include those other methods. It should also be noted that the geometry of the electro-optical polymer layer in FIGS. 10 and 11 is demonstrative and not limited to that depicted. The spacing, relative amounts, and geometries of the optical material and the electro-optical polymer material may be of various types.

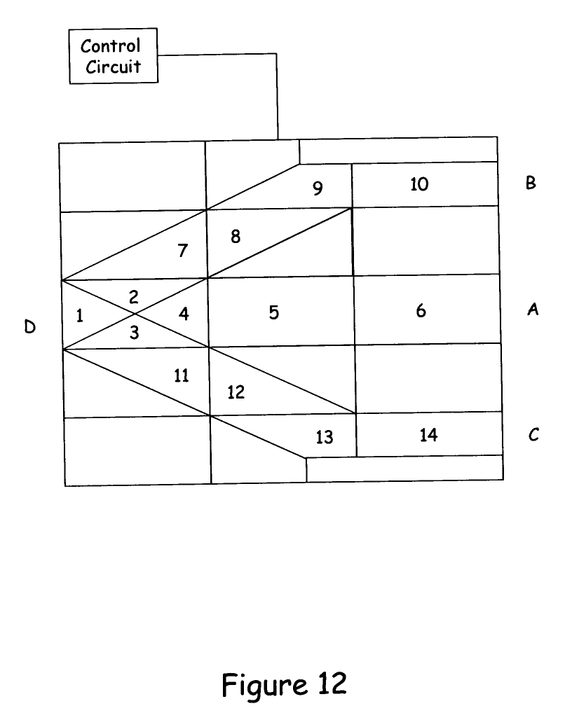

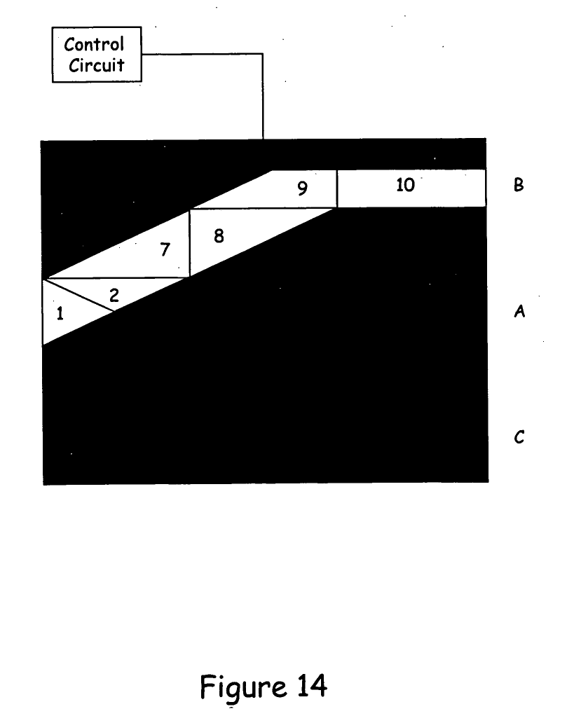

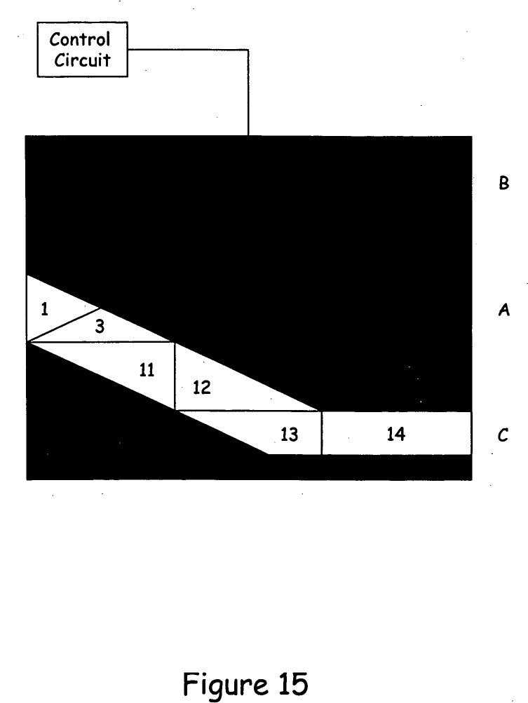

FIGS. 12-15 are schematic diagrams detailing the interaction of multiple sections of the waveguide operating in a reconfigurable manner according to an aspect of the invention. A control circuitry is coupled to an array of electro-optical polymer devices, as described in preceding sections. For demonstrative purposes, the electro-optical polymer device portions are biased to a non-optical-transmitting mode in this diagram. FIG. 12 depicts the layout of such an array when all of the sections have voltages applied to them by the direction of the coupled control circuit. When the voltage is applied, all the sections are made to be optically transmitting.

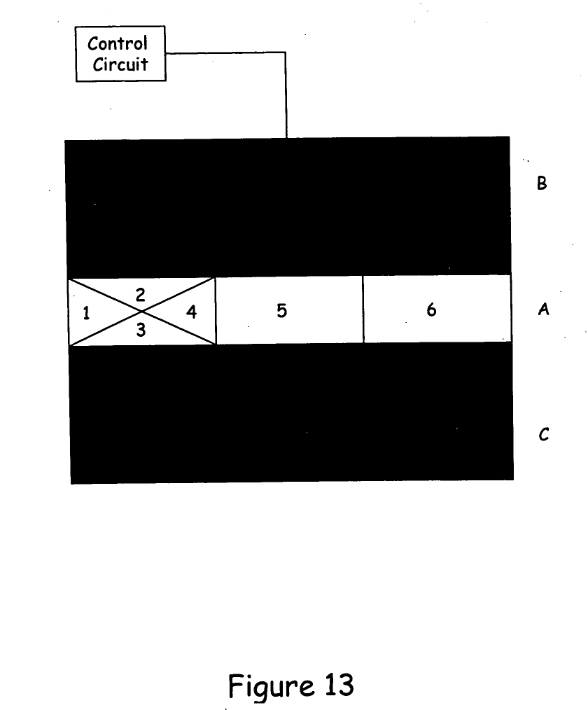

In FIG. 13, the control circuitry directs that current flow to the circuitry layers in the sections 1-6 in the electro-optical polymer devices. Accordingly a light path is opened from point D to point A. In FIG. 12b, the control circuitry directs that the sections 1, 2, and 7-10 to transmit light. Accordingly a light path is opened from point D to point B. In FIG. 12c, the control circuitry directs that the sections 1, 3, and 11-14 to transmit light. Accordingly a light path is opened from point D to point B.

It should be noted that the preceding description deals with the non-transmitting biased type devices described. The design of functional units made from transmitting biased type devices is also envisioned and easily derived from the discussion above. Additionally, the construction of similar types of functionality using a combination of non-transmitting biased type devices and transmitting biased type devices may also be implemented with appropriate control functionality.

The invention may be employed or used in a number of fields. These include inclusion in logic elements in a completely optical or hybridized optical logic circuit, use in a re-configurable processor employing optical channels, use in any re-configurable optical semiconductor logic device, use as wavelength conversion elements in wavelength division multiplexing and/or demultiplexing switching systems for telecommunications, external modulation of optical signals for digital signal transmission, variable optical attenuation purposes, use in an N-by-N crossbar switch used in telecommunications, tunable lasers, coding, decoding, and encryption for communication security purposes, or a optical add/drop multiplexer. Of course, any portion of a system using an optical path may be implemented, including any logic function implemented on a semiconductor device.

This description is provided only as example. It is to be understood that various modifications to the preferred embodiments will be readily apparent to those skilled in the art.

Thus, while preferred embodiments of the invention have been disclosed, it will be readily apparent to those skilled in the art that the invention is not limited to the disclosed embodiments. Correspondingly, we claim:

1. An apparatus for a dynamically re-configurable waveguide, comprising:
a baseplate;
an electro-optic material coated plate with ground electrode spaced apart from the baseplate;
an electron emitting array formed on the baseplate, the array comprising a plurality of emitters positioned so that electrons emitted from any of the plurality of emitters impinge on a particular section of the electro-optic material coated plate;
the emitters having a top portion and a bottom portion, the top portion nearer to the electro-optic material than the bottom portion; and
at least one spacer operationally positioned between and separating the baseplate and the electro-optic material coated plate,
wherein the electrons emitted from the emitters are controlled so that they affect the value of the refractive index of the electro-optic material.

2. The apparatus of claim 1 wherein the emitters are conical in nature.

3. The apparatus of claim 1 wherein the density of emitters is approximately 10⁸ per square centimeter.

4. The apparatus of claim 1 wherein the density of emitters is more than 10⁸ per square centimeter.

5. The apparatus of claim 1 wherein the distance between the adjacent top portions is less than a wavelength of a propagated light.

6. The apparatus of claim 1 wherein the electron emitting array comprises a plurality of gates, the gates disposed in a layer above each emitter, each of the plurality of gates having a dimension of less than half the wavelength of a propagated light.

7. The apparatus of claim 1 wherein the a plurality of emitters are placed into a group, the group defining a set of controllable emitters.

8. The apparatus of claim 7 wherein the group contains approximately one hundred emitters.

9. The apparatus of claim 7 wherein the group contains more than one hundred emitters.

10. The apparatus of claim 7 wherein the group forms a triangular shape.

11. The apparatus of claim 1 wherein said electron emitting array creates, in response to a common applied voltage, a two-dimensional subwavelength periodicity on the electro-optic material coated plate with a different refraction index.

12. The apparatus of claim 1 wherein said electron emitting array, in response to a common applied voltage which is parallel to polarization vector of the electro-optic material, creates a region in the electro-optic material that is characterized by total internal reflection guiding.

13. The apparatus of claim 1 wherein said electron emitting array, in response to a common applied voltage which is parallel to polarization vector of the electro-optic material, creates a region in the electro-optic material that is characterized by photonic band gap guiding.

14. The apparatus of claim 1 wherein said electron emitting array adaptively creates, in response to a signal, a waveguide in the electro-optic material.

15. A semiconductor chip containing a reconfigurable optical waveguide, the chip comprising:
a wave guide layer, the layer comprising:
a first material having a first refractive index;
a second material having a second refractive index and a third refractive index, the second material operable to change from the second refractive index to the third refractive index depending upon the presence of an electric field in proximity to the second material;
a first electric conducting layer relatively close to the wave guide layer;
a second electric conducting layer positioned apart from the first electric conducting layer, a current operable to flow in the second electric conducting layer and to produce an electric field in the wave guide layer; and
wherein the refractive index of the second material is operable to change in response to the electric field produced by the current.

16. The semiconductor chip of claim 15, the wave guide layer further comprising the second material interspersed within a matrix of the first material.

17. The semiconductor chip of claim 15, the second material comprising an electro-optic polymer.

18. The semiconductor chip of claim 15, wherein the first refractive index and the and the second refractive index being approximately equal when the electric field is present.

19. The semiconductor chip of claim 15, wherein the first refractive index and the and the third refractive index being approximately equal when the electric field is present.

20. A configurable waveguide, comprising:
a cathode including an array of emitter tips;
a gate; and
an electro-optical material having a variable refractive index that is dependent on a voltage differential applied across said cathode and gate.

21. The configurable waveguide of claim 20 wherein one or more of said emitter tips is conical-shaped.

22. The configurable waveguide of claim 20 wherein one or more of said emitter tips is cylindrical-shaped.

23. The configurable waveguide of claim 20 wherein the electro-optical material comprises a polymer.

24. The configurable waveguide of claim 20, further comprising an optical material interleaved with said electro-optical material, said optical material having a refractive index that is independent of the voltage differential applied across said cathode and gate.

25. The configurable waveguide of claim 20 wherein an electric field component produced by said voltage differential is parallel to a polarization vector of said electro-optical material.

26. A configurable waveguide, comprising:
an array of emitter tips arranged in one or more groups;
a gate; and
an electro-optical material having one or more portions corresponding to said one or more groups, each portion having a variable refractive index that is dependent on a voltage differential applied across said gate and the one or more groups associated with said each portion.

27. The configurable waveguide of claim 26 wherein the groups are separately controllable, such that the refractive index of a first portion of said electro-optical material associated with a first group may be varied relative to the refractive index of a second portion of said electro-optical material associated with a second group.

28. The configurable waveguide of claim 26 wherein one or more of said emitter tips is conical-shaped.

29. The configurable waveguide of claim 26 wherein one or more of said emitter tips is cylindrical-shaped.

30. The configurable waveguide of claim 26 wherein the electro-optical material comprises a polymer.
